(19) United States
(12) Patent Application Publication
(10) Pub. No.: US 2012/0181358 A1
(43) Pub. Date: Jul. 19, 2012

(54) COIL CONTACT

(76) Inventors: Roland Herwig, Besigheim (DE); Dieter Roehr, Schluesselfeld (DE); Florian Dirscherl, Bamberg (DE); Gueray Ikizalp, Bamberg (DE); Udo Schaich, Stuttgart (DE); Thomas Sommer, Bamberg (DE); Thomas Hohe, Bamberg (DE); Cetin Yilmazer, Bamberg (DE)

(21) Appl. No.: 12/740,769

(22) PCT Filed: Sep. 18, 2008
(86) PCT No.: PCT/EP08/62437

§ 371 Date: Jul. 8, 2010

(30) Foreign Application Priority Data
Oct. 30, 2007 (DE) 102007052204.7

(51) Int. Cl. B05B 1/30

(52) U.S. Cl. 239/585.1

(57) ABSTRACT

The invention relates to a magnetic assembly (10) of a solenoid valve, particularly for actuating a fuel injector, having a housing (12, 16) receiving a magnetic core (28) having a magnetic coil (26). Electrical contacts (32) are led through penetrations (34) out of the housing (12, 16). The electrical contacts (32) in the housing (12, 16) for supplying the magnetic coil (26) with current are attached by means of an adhesive connection (50).

### PRIOR ART

German Patent Disclosure DE 196 50 865 A1 relates to a solenoid valve for controlling the fuel pressure in a control chamber of an injection valve, for instance of a common rail injection system, for supplying self-igniting internal combustion engines with fuel. By way of the fuel pressure in the control chamber, a reciprocating motion of a valve body is controlled, with which body an injection opening of the injection valve is opened or closed. The solenoid valve includes an electromagnet, a movable armature, and a valve member, which is moved with the armature and is urged in the closing direction by a valve closing spring and which, cooperating with the valve seat of the valve member, controls the expulsion of fuel from the control chamber.

A common rail fuel injector with a two-part armature that is actuated by a solenoid valve is known. In the currentless case, the armature exerts the closing force on a valve ball. When current is supplied to the electromagnet, the armature moves upward by the length of the armature stroke, counter to the closing force acting on the valve ball, and opens an outflow valve. An armature guide, which is screwed fixedly in the injector body of the fuel injector, receives the armature bolt. On the armature bolt, the armature plate is guided, which in turn is attracted by the electromagnet. Because of the guidance play, the armature bolt can tilt in the armature guide. The armature plate can in turn tilt on the armature bolt, so that the total tilting of the armature bolt and armature plate assembly relative to the main axis of the injector can be defined as the sum of the guidance plays.

International Patent Disclosure WO 03/038844 A1 relates to a reduced-mass magnet coil holder. A magnet arrangement is proposed which includes a magnet coil that is surrounded by a magnet pot. The magnet coil is connected electrically conductively to contact lugs. An interstice between the outside of the magnet coil and the inside of the magnet pot is embodied such that a flowable material can be poured into it. The magnet coil is surrounded by a thin-walled coil holder, onto which tubular contact guide elements are integrally formed. The coil holder embodied with thin walls is made from a temperature-resistant plastic material mixed with mineral fillers.

German Patent Disclosure DE 197 14 812 A1 relates to a magnet coil. The magnet coil is formed by a winding wire, which is wound on a winding holder. A magnet coil of this kind is used among other ways in solenoid valves that are employed in fuel pumps of internal combustion engines for controlling the delivery quantity and the course of delivery. In operation, the solenoid valves are bathed at least in part by fuel subjected to high pressure. To avoid contact with the fuel, it is necessary that the magnet coil be encapsulated. Especially in common rail fuel injection systems or unit fuel injectors, solenoid valves with extremely fast switching times are needed. The fast switching times mean that the magnet coil heats up in operation, and therefore care must be taken to dissipate heat from the magnet coil, since its thermal load in operation is unfavorable.

### DISCLOSURE OF THE INVENTION

According to the invention, it is proposed that contacting of the magnet coil of a solenoid valve be done via a material-locking connection. The use of adhesive technology makes it possible to economize on installation space and to utilize the medium that produces a material-locking connection to seal off leakage paths that develop. Via a coil contact embodied as a material-locking connection, which is joined for instance as a layer of adhesive to the housing of the magnet assembly, sealing can be achieved.

In O-rings used previously for ducting and sealing off the magnet coil contacts, or when glass seals are used, more installation space is necessary, but that space can be reduced when the embodiment proposed according to the invention is employed. Particularly, by the embodiment of an adhesive layer on the coil contact bushing, a better sealing effect can be achieved.

The improvement in the sealing action, in the embodiment of an adhesive bond, is based on the joining of the partners to be joined to the adhesive material acting as the sealing element. For the sealing, pressing the sealing element onto the partners to be joined is not necessary. Hence there is no longer a resultant risk of minimizing the sealing action because of an ensuing relaxation of the sealing element over the service life—as in the case when an O-ring is used. Thus the safety of the sealing action over the service life of the magnet assembly is increased. In addition, a cone, which is employed when glass seals are used to generate the contact pressure, becomes superfluous. Both the cost-intensive production of the cone and what must be called the critical press-fitting process can be omitted. Moreover, such aids in assembly as insertion chamfers can be dispensed with. Product costs are minimized, and process safety is increased by the elimination of what must be classified as a critical process step.

Moreover, in the embodiment of a material-locking connection, such as an adhesive connection, it must be stressed that the plastic used adapts to the surface of the partners to be joined. Scoring or similar irregularities are filled up by the adhesive. Grooves that extend from the interior to the exterior and which when O-ring seals are used can present problems can no longer act as critical leakage paths, since they become filled by the adhesive medium that in this case acts as a sealing medium. As a consequence, the demands in terms of surface quality of the sealing face can be made less stringent, which in turn represents a cost reduction in the manufacturing process.

Since for sealing off by means of adhesive only a relatively slight radial gap of approximately 150 μm is required, the through bores in the housing of the magnet assembly can be selected as smaller, compared to the versions employed until now. For the fuel injector, this means on the one hand that the installation space is reduced and on the other that the strength of the base body is not impaired as severely. Bores interlaced in one another that extend in the interior of the injector body of the fuel injector can be more easily realized if the embodiment proposed according to the invention is employed. By this it is meant to say that the degree of freedom with regard to the choice of the interlacing angle becomes greater, and the injector body is more massive, which favorably affects its high-pressure strength.

The same is true for the installation space required in the axial direction. The shorter a fuel injector is, the more favorable that is with regard to the space conditions prevailing at the cylinder head of an internal combustion engine and in terms of the depth at which the bores, receiving the fuel injectors, have to be made in the cylinder head of the engine.

By adapting the layer thickness of the adhesive or the adhesive medium, the adhesive length, and the surface area of the partners to be joined to be joined together, it is comparatively simple, by employing the embodiment proposed according to the invention, to adapt the sealing element called an “adhesive layer” to altered pressure conditions. This means that the coil contact proposed according to the invention can, by means of a material-locking connection, be used in both the low-pressure region and the high-pressure region.

As an element to be led through and that contacts the magnet coil, not only the contact pins used previously but dimensionally flexible cables and wires as well can be employed. The embodiment proposed according to the invention makes it possible for the structural free spaces that are created in production to be expanded with a view to the use of these dimensionally flexible cables or wires. For instance, fuel injectors can be made that have a radial instead of the previously employed axial alignment of the coil contact and of the bushings that are required for it. The bushing is adapted to the existing free spaces.

Moreover, the embodiment proposed according to the invention of a material-locking connection between a contact pin, or dimensionally flexible cable or wire, and the housing of the magnet assembly makes it possible to reduce the number of parts. Moreover, there is a favorable effect on the bushing with regard to its geometry and surface roughness. Finally, the process steps necessary for assembly are minimized and production costs are thereby lowered.

### BRIEF DESCRIPTION OF THE DRAWINGS

The invention is described in further detail below in conjunction with the drawings.

Shown are:

FIG. 1, the previous layout of a magnet assembly, in particular for actuating a fuel injector;

FIG. 2, a sectional view through the embodiment proposed according to the invention for a magnet assembly for actuating a fuel injector; and

FIG. 3, a perspective view of a magnet assembly of FIG. 2, shown partly broken open.

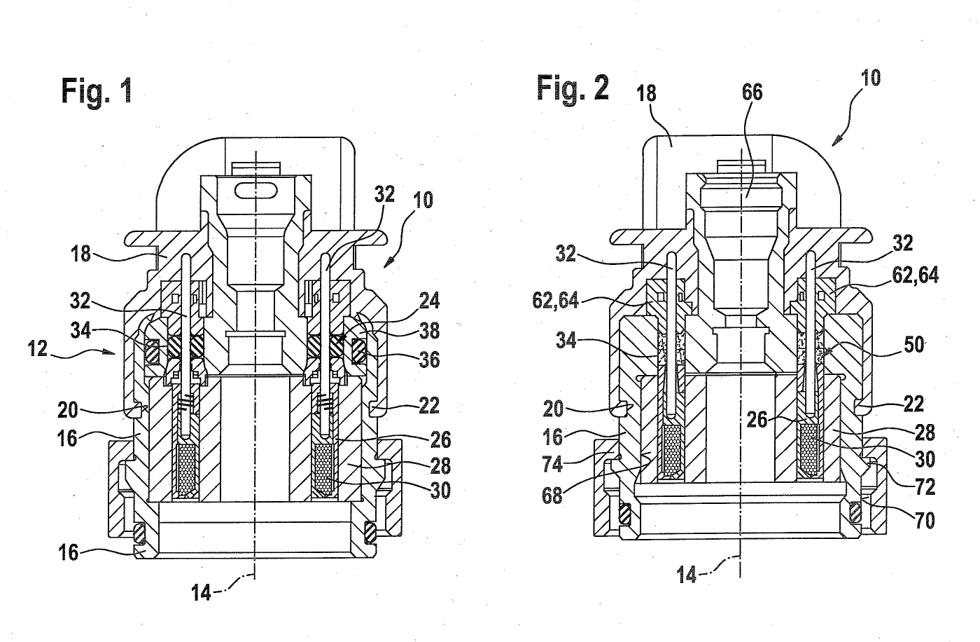

FIG. 1 a magnet assembly 10, which includes a housing 12. The housing 12 comprises a magnet sleeve 16 and a cap 18. The magnet assembly 10—except for the cap 18—is constructed symmetrically to an axis 14. An annular groove 20 extends in the jacket face of the magnet sleeve 16 and is engaged by a detent ring 22 of the cap 18.

A magnet core 28 is received in the magnet sleeve 16, and a magnet coil 26 is embedded in it. The magnet coil 26 is supplied with current via contact pins 32. The contact pins 32 are extended through bushings 34 of a housing part 38. The O-rings 24 each seal off the contact pins 32 in the bushings 34 of the housing part 38.

It can be seen from the view in FIG. 1 that one O-ring 24 is fitted into each bushing 34 in the housing part 38. The O-rings 24 that are used in the version in FIG. 1 have a tendency to relaxing, so that over the service life of the magnet assembly 10, the sealing action lessens, and leakage paths arise.

### EMBODIMENTS

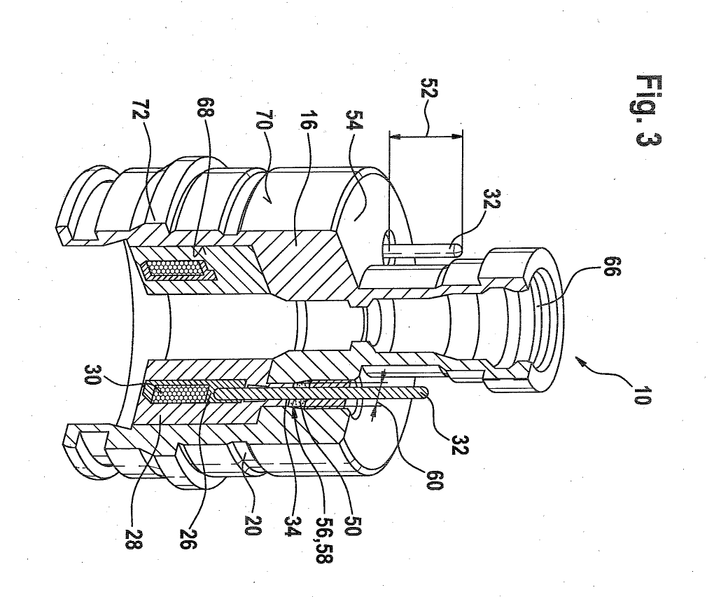

From the view in FIG. 2, a section can be seen through the embodiment, proposed according to the invention, of the magnet assembly of a solenoid valve.

As can be seen from the view in FIG. 2, the magnet assembly 10 includes the magnet sleeve 16, which is closed by the cap 18. The cap 18 is received in form-locking fashion with a detent ring 22 in an annular groove 20 on the outer circumferential surface of the magnet sleeve 16. The magnet core 28, in which the magnet coil 26 is embedded, is located in the magnet sleeve 16 of the magnet assembly 10 as shown in FIG. 2. The magnet coil 26 includes many winding wires 30, which can be supplied with current via electric contact elements, which may for instance be embodied as contact pins 32. As can be seen from the sectional view in FIG. 2, the electric contact elements 32 extend through bushings 34 in the magnet sleeve 16. In comparison to the view in FIG. 1, the bushings 34 are embodied with a reduced diameter 60; see the perspective view in FIG. 3. The sealing between the electric contact elements 32 in the bushing 34 of the magnet sleeve 16 is brought about via a material-locking connection 50. The material-locking connection 50 is represented by a viscous adhesive—to name one example—which after introduction into the gap between the electric contact elements 32 and the boundary wall of the bushings 34 is hardened by a suitable hardening process. By adapting the course of the process in the sealing, it is assured that the gap, including any irregularities that may be present, such as scoring or dents and the like, will be filled without bubbles. The hardening is effected in the hardening process as a function of the adhesive, either by heat, by air exclusion, by UV radiation, or by other mechanisms. As an alternative to viscous adhesives, and given suitable embodiment of the sealing geometry between the electric contact elements 32 and the boundary wall of the bushing 34, melt-on adhesives or ready-made adhesive tapes may be employed, for the sake of simplifying the process flows. The adhesive from which the material-locking connection 50 between the electric contact elements 32 and the boundary wall of the bushings 34 is made depends on the properties of the medium to be sealed off, whether it is water, oil, diesel, fuel, or other fuels or the like, as well as on the sealing geometry. Not only the possible joining direction and the gap in construction tolerances and the like, but also the needs in terms of timing for the production process play a major role.

The sealing action and the insulation action of the adhesive at the material-locking connection 50, in the adhesive bond, is based on the material-locking connection of the partners to be joined, that is, the material of the electric contact elements 32 and the material of the boundary wall of the bushing 34 in the magnet sleeve 16. As an alternative to embodying the electric contact elements as relatively rigid contact pins, flexible films or foils or cables and the like, which have reduced dimensional stability compared to contact pins, may also be employed. For the sealing, pressing of the sealing element, in this case the adhesive compound, onto the partners to be joined is not necessary. Relaxation of the sealing element, that is, of the material-locking connection 50, when an adhesive is employed is eliminated. The adhesive used in the context of the material-locking connection 50 adapts to the surface of the partners to be joined. Scoring or similar irregularities are filled up in the process of the bubble-free filling of the gap between the electric contact elements 32 and the material comprising the boundary wall of the bushing 34. The grooves extending from the interior to the exterior, precisely when the O-rings 24 shown in FIG. 1 are used to bring about sealing, are a problem, since they form critical leakage paths. By the provision proposed according to the invention of introducing an adhesive medium that makes a material-locking connection 50, the demands in terms of surface quality of the sealing faces can be made less stringent, which entails a further cost saving.

In the embodiment proposed according to the invention, as a result of the sealing by means of the material-locking connection 50, only a minimal radial gap of approximately 150 μm is needed, so that the diameter of the through bores, that is, of the bushings 34, can be selected to be smaller in comparison to the prior versions and can be embodied with the aforementioned reduced diameter 60. For the fuel injector, the consequence is that less installation space is required, and the strength of the injector body is not reduced as much. Moreover, interlaced bores extending inside one another can more easily be realized since, in the embodiment proposed according to the invention, because of the smaller dimensioning of the bushings 34, the degree of freedom with regard to the selection of the interlacing angles can be increased, which on the one hand is an advantage from the production standpoint and on the other increases the high-pressure strength of the fuel injector proposed according to the invention. The cause of this is that remaining wall thicknesses between the interlaced bores inside the injector body can be made thicker, thus improving the high-pressure strength.

The adhesive layer thickness, adhesive length, and surface area of the partners to be joined, that is, of the material comprising the bushings 34 and the jacket face of the electric contacts, makes comparatively simple adaptation of the material-locking connection 50 to changed pressure conditions possible. It is thus possible to use the material-locking connection 50, which is made by means of the adhesive, both in the low-pressure region and in the high-pressure region of a fuel injector.

Instead of the electric contact elements 32 embodied as contact pins, shown in FIG. 2, dimensionally flexible electric contact elements 32, such as cables or wires, can be employed. Moreover, instead of an axial alignment of the bushing 34 as embodied previously, a radial orientation of the bushing can be made, which considerably increases the structural and production-related free space. With the embodiment proposed according to the invention, the bushing 34 can be adapted to the existing free spaces, and the injector design is not limited because of the requirement of the bushing 34. By means of the embodiment proposed according to the invention, a reduction in the number of parts, a simplified embodiment of the bushing 34 in terms of its geometry (see particularly its reduced diameter 60) and the surface quality can be attained. Moreover, when the embodiment proposed according to the invention is used, minimizing the process steps necessary for assembly can be achieved, which further favorably affects product costs.

FIG. 2 also shows that the electric contact elements 32, shown in this embodiment and embodied as contact pins, make contact with plug lugs 64 of flat plugs 62. The electric contact elements 32 embodied as contact pins extend essentially parallel to the injector axis 14. Instead of the electric contact elements 32 shown in FIG. 2 and embodied as contact pins, dimensionally flexible electric contact elements 32 such as cables or wires that have a lesser stiffness can also be employed for contacting the magnet coil 26 that is embedded inside the magnet core 28.

FIG. 2 further shows that the cap 18 is secured in form-locking fashion in the annular groove 20 of the magnet sleeve 16 by means of the detent ring 22. The magnet sleeve 16 in turn is fixed by means of a union element 74, which engages the jacket face 70 of the magnet sleeve 16 above a collar 72. FIG. 2 also shows that the outer circumference of the magnet core 28, in which the magnet coil 26 with its many winding wires 30 is embedded, rests on a contact face 68 on the inside of the magnet sleeve 16 of the magnet assembly 10.

FIG. 3 shows a perspective view of the magnet assembly which is shown in section in FIG. 2 and is used in particular for actuating a fuel injector.

From the perspective view in FIG. 3 it can be seen that the housing 12, 16 of the magnet assembly 10 proposed according to the invention has a return opening 66, above the magnet core 28 in which the magnet coil 26 is embedded. A control quantity, that is, fuel diverted from a control chamber, which is diverted from the control chamber upon actuation of the injection valve member, flows via the return opening 66 to a return, not shown in detail in the views in FIGS. 2 and 3, on the low-pressure side.

FIG. 3 also shows that via a face end 54 of the magnet sleeve 16, the electric contact elements 32, embodied here as contact pins, protrude to a distance 52. Within that protrusion distance 52, the electric contact elements 32 that in the embodiment of FIG. 3 are embodied as contact pins are electrically contacted by flat plugs 62 with plug lugs 64 (see the view in FIG. 2). FIG. 3 shows that the magnet core 28, in which the magnet coil 26 is embedded, rests on a contact face 68 on the inside of the magnet sleeve 16 and is glued into it. The jacket face 68 of the magnet sleeve 16 has the collar 72, already mentioned in conjunction with FIG. 2, which is overlapped by a union element 74 (see the view in FIG. 2). By means of the union element 74 as shown in FIG. 2, the magnet sleeve 16 of the magnet assembly 10 is fixed on the injector body of a fuel injector not shown in detail in the views in FIGS. 2 and 3.

It can also be seen from the view in FIG. 3 that the electric contact elements 32, embodied in this embodiment as contact pins, penetrate bushings 34 in the magnet sleeve 16. The bushings 34 are made with a reduced diameter 60. The resultant gap in the radial direction between the inner wall of the bushing 34 having the reduced diameter 60 and the outer circumferential surface of the electric contact elements 32, shown in FIG. 3 and preferably embodied as contact pins, is filled in a material-locking connection 50 with an adhesive medium or an adhesive. The material-locking connection 50 between the outer circumferential face of the electric contacts 32 embodied as contact pins and the inner boundary of the bushings 34 acts as a seal. This seal compensates for surface roughness between the partners to be joined together, which in the present case are the jacket face of the electric contact elements embodied as contact pins and the inside of the bushings 34 in the magnet sleeve 16.

The material-locking connection 50, which may be represented by a viscous adhesive, ready-made adhesive tapes, or by melting on of the adhesives, also serves as a seal between the low-pressure region and the high-pressure region of a fuel injector.

From FIG. 3, it can be seen that the electric contact elements 32, embodied in this embodiment as contact pins, protrude past the face end 54 of the magnet sleeve 16 by a distance 52. Inside this region, formed by the distance 52, of the electric contact elements 32 embodied as contact pins, the flat plugs 62 with plug lugs 64 shown in FIG. 2 are mounted. There is accordingly an electrical connection between the magnet coil 26, received in the magnet core 28, via the electric contact elements 32. These elements may—as shown in FIGS. 2 and 3—be embodied as pins which extend parallel to the axis 14 of the magnet assembly 10. In addition, the embodiment of the electric contact elements 32 as dimensionally flexible cables or flexible films or foils is also possible. In the views in FIGS. 2 and 3, the electric contacts 32—embodied as contact pins—extend parallel to the axis 14 of the magnet assembly 10 in the axial direction. In a different possible embodiment, the electric contact elements 32, whether they are contact pins or dimensionally flexible cables, wires or flexible films or foils or the like, can be introduced into the magnet sleeve 16 such that they extend in the radial direction and can contact the magnet coil 26 in the radial direction.

As can also be seen from the view in FIG. 3, the electric contact elements 32 embodied as contact pins extend through bores in the magnet sleeve 16. The through bores are embodied with a reduced diameter 60, compared to the view in FIG. 1. The reduced diameter 60 makes a more-massive mode of construction of the housing 16 possible, that is, of the magnet sleeve of the magnet assembly 10.

By means of the material-locking connection 50 made of viscous adhesive, melt-on adhesive or ready-made adhesive tapes, a secure seal can be attained. The sealing via the material-locking connection 50, which is embodied as an adhesive bond, does not require pressing the “sealing element” onto the partners 32, 34 to be joined. The “sealing element” in the embodiment of the invention is formed by the adhesive compound. This avoids minimizing the sealing action from relaxation of the sealing element over its service life in the way that can occur for example with O-rings 24. Moreover, the material-locking connection 50, that is, the adhesive, enables an adaptation to the surface area of the partners to be joined together, which in the present case are the electric contact elements 32 and the boundary of the bushings 34. Scoring or similar irregularities are filled with the adhesive compound. Grooves that extend from the interior to the exterior and that present problems specifically with O-ring seals no longer act as a critical leakage path. As a consequence, the surface quality of the surfaces to be joined together, that is, the sealing faces, can be reduced. By adaptation of the adhesive layer thickness, adhesive length, and surface area of the partners to be joined together, that is, of the boundary of the bushing 34 and of the jacket face of the electric contact elements 32, the sealing element, that is, the material-locking connection 50, can be adapted to altered pressure conditions. Thus the possibility presents itself of employing the material-locking connection 50, proposed according to the invention, on both the low-pressure and on the high-pressure side of a fuel injector.

It can furthermore be seen from the view in FIG. 3 that as a result of the magnet sleeve 16, a return 66 extends on the low-pressure side, by way of which return the diverted control quantity from a control chamber of a fuel injector is delivered to the return region on the low-pressure side of a fuel injection system. FIG. 3 furthermore shows that the magnet core 28 with the magnet coil 26 let into it rests on a contact face 68 on the inside of the magnet sleeve 16. Both the annular groove 20, on which the detent ring 22 of the cap 16 of the magnet assembly 10 is locked, and the encompassing collar 72, which as indicated in the view in FIG. 2 enables securing the magnet sleeve 16 to the injector body of the fuel injector, are located on the jacket face 70 of the magnet sleeve 16.

1. A magnet assembly (10) of a solenoid valve, in particular for actuating a fuel injector, having a housing (12, 16) that receives a magnet core (28) with a magnet coil (26), having electric contact elements (32), which are extended through bushings (34) out of the housing (12, 16), characterized in that the electric contact elements (32) are fixed in the housing (12, 16) with a material-locking connection (50).

2. The magnet assembly (10) as defined by claim 1, characterized in that the electric contact elements (32) are embodied as contact pins, cables, flexible film or foil or wires, the jacket faces of each of which represent one of the partners to be joined of the material-locking connection (50).

3. The magnet assembly (10) as defined by claim 1, characterized in that a boundary of at least one bushing (34) of the housing (12, 16) is one partner to be joined of the material-locking connection (50).

4. The magnet assembly (10) as defined by claim 1, characterized in that the electric contact elements (32) extend parallel or perpendicular to the axis (14) of the magnet assembly (10).

5. The magnet assembly (10) as defined by claim 1, characterized in that the material-locking connection (50) is embodied as an adhesive bond, which acts as a seal of a region, in particular a fuel-filled region, of a fuel injector.

6. The magnet assembly (10) as defined by claim 1, characterized in that the material-locking connection (50) fills a gap between the electric contact element (32) and the at least one bushing (34).

7. The magnet assembly (10) as defined by claim 5, characterized in that the adhesive bond (50) is represented by a viscous adhesive, by a melt-on adhesive, or ready-made adhesive tapes, which harden after the material-locking connection (50) has been made.

8. The magnet assembly (10) as defined by claim 1, characterized in that the bushings (34) are embodied as through bores with a reduced diameter (60) in the housing (12, 16).

9. The magnet assembly (10) as defined by claim 1, characterized in that the material-locking connection (50) acts as a seal between a low-pressure region and a high-pressure region of a fuel injector.

10. The magnet assembly (10) as defined by claim 1, characterized in that by means of the material-locking connection (50) between the electric contact elements (32) and the material of the bushing (34), surface irregularities of the partners to be joined (32, 23) are filled, and leakage paths are closed.
